(19) United States
(12) Patent Application Publication
(10) Pub. No.: US 2018/0020622 A1
(43) Pub. Date: Jan. 25, 2018

(54) Agronomic Database and Data Model

(71) Applicant: CiBo Technologies Inc., Cambridge, MA (US)

(72) Inventor: Ryan Richt, Cambridge, MA (US)

(21) Appl. No.: 15/259,030

(22) Filed: Sep. 7, 2016

Related U.S. Application Data
(60) Provisional application No. 62/366,434, filed on Jul. 25, 2016.

(51) Int. Cl. A01G 1/00; G06F 17/30; G06F 17/50

(52) U.S. Cl. CPC A01G 1/001; G06F 17/5009; G06F 17/30

(57) ABSTRACT

Methods, systems, and apparatus, including computer programs encoded on computer storage media, for determining and improving agronomic characteristics.

### CLAIM OF PRIORITY

This application claims priority under 35 U.S.C. §119(e) to provisional U.S. Patent Application 62/366,434, filed on Jul. 25, 2016, the entire contents of which are hereby incorporated by reference.

### BACKGROUND

Agronomy is the science and technology of producing and using plants for food, fuel, fiber, ornamentation and land reclamation. Agronomy encompasses work in the areas of plant genetics, plant physiology, meteorology, and soil science. The National Cooperative Soil Survey is the largest natural resource information system in the world, however, information in the soil survey is frequently incomplete and inaccurate.

### SUMMARY

This specification describes technologies related to an agronomic data model that analyzes agronomic data maintained by an agronomic database.

In general, one innovative aspect of the subject matter described in this specification can be embodied in a data processing apparatus for improving crop yield of a farmable zone by processing data records, retrieved from one or more databases, representative of reference agronomic inputs and a reference crop yield of the farmable zone. The data processing apparatus includes one or more sensors for collecting data indicative of reference agronomic inputs and a reference crop yield of a farmable zone. The data processing apparatus includes one or more databases storing data records comprising the collected data indicative of the reference agronomic inputs and the reference crop yield for the farmable zone. The data processing apparatus includes one or more processing devices and one or more machine-readable hardware storage devices comprising instructions that are executable by the one or more processing devices to cause the one or more processing devices to perform operations. The operations include retrieving, from the one or more databases, the data records comprising the collected data indicative of the reference agronomic inputs and the reference crop yield for the farmable zone. The operations include parsing the retrieved data records to identify the reference agronomic inputs. The operations include iteratively sampling possible combinations of agronomic inputs, the combinations of agronomic inputs determined at least partly based on the reference agronomic inputs. The operations include for one or more iterations, generating data indicative of a prediction of crop yield for the farmable zone using an agronomic simulator and a sample for that iteration, comparing the predicted crop yield to the reference crop yield; and selecting a next sample based, at least in part, on the comparison. The operations include selecting a probable set of agronomic inputs based, at least in part, on the iterative sampling. The operations include causing transformation of one or more soil conditions of soil based, at least in part, on the probable set of agronomic inputs.

Other embodiments of this aspect include corresponding methods, computer systems, and computer programs recorded on one or more computer storage devices, each configured to perform the aforementioned operations. A system of one or more computers can be configured to perform particular actions by virtue of having software, firmware, hardware, or a combination of them installed on the system that in operation causes or cause the system to perform the aforementioned operations. One or more computer programs can be configured to perform particular actions by virtue of including instructions that, when executed by data processing apparatus, cause the apparatus to perform the aforementioned operations.

The foregoing and other embodiments can each optionally include one or more of the following features, alone or in combination. Selecting a next sample based, at least in part, on the comparison may be based, at least in part, on a sensitivity of at least one agronomic output in an output set of the agronomic simulator to a value of an agronomic input of an input set to the agronomic simulator. The operations may include identifying a set of agronomic inputs that are responsive to an intervention, updating at least one agronomic input in the set consistent with an effect of applying at least one intervention to the farmable zone, using the agronomic simulator to predict an updated agronomic output using the updated at least one agronomic input, and in response to determining that the updated agronomic output represents an improvement over a reference agronomic output, generating a report identifying the intervention. Determining that the updated agronomic output represents an improvement over the reference agronomic output may include determining that the updated agronomic output is greater than the agronomic output in the output set. Determining that the updated agronomic output represents an improvement over the reference agronomic output may include determining that the reference agronomic output is less than the agronomic output in the output set. Selecting a next sample may be based, at least in part, on identifying a sample that includes an agronomic input that is outside a threshold value, and excluding the sample from selection as the next sample. Comparing the predicted crop yield to the reference crop yield may include applying a scoring function to the predicted crop yield and the reference crop yield, and wherein selecting a next sample based, at least in part, on the comparison comprises adjusting selection of a next sample based, at least in part, on results of the scoring function. The operations may include segmenting a farmable region into one or more farmable zones based, at least in part, on one or more of a yield map, stability map, soil survey map, satellite map, and elevation map, and determining a probable set of agronomic inputs for each of the one or more farmable zones. Causing transformation of one or more soil conditions of soil based, at least in part, on the probable set of agronomic inputs may include altering one or more levels of one or more nutrients in the soil or altering a water level of the soil. Causing transformation of one or more soil conditions of soil based, at least in part, on the probable set of agronomic inputs may include transforming one or more soil conditions of the soil.

In general, another innovative aspect of the subject matter described in this specification can be embodied in a data processing apparatus for improving a farmable zone by processing data records to infer an agronomic characteristic, the data records representative of reference agronomic inputs. The data processing apparatus includes one or more databases storing data records representative of reference agronomic inputs and a reference agronomic output. The data processing apparatus includes one or more processing devices and one or more machine-readable hardware storage devices storing instructions that are executable by the one or more processing devices to cause the one or more processing devices to perform operations. The operations include accessing, from the one or more databases, the stored data records. The operations include processing the stored data records to obtain an initial input set of agronomic inputs based, at least in part, on the reference agronomic inputs, the input set including a potential value for an agronomic characteristic. The operations include iteratively applying an agronomic simulator, with each iteration applying the agronomic simulator to a particular input set, each iteration comprising: predicting agronomic outputs using the agronomic simulator processing that particular input set, based on the predicted agronomic outputs, determining a score of that particular input set by applying a scoring function of predicted agronomic outputs to one or more of the reference agronomic outputs, and based on the score, adjusting agronomic inputs in that particular input set to generate another input set. The operations include selecting an input set based a score of that input set relative to scores of other input sets. The operations include inferring the agronomic characteristic based, at least in part, on the selected input set.

Other embodiments of this aspect include corresponding methods, computer systems, and computer programs recorded on one or more computer storage devices, each configured to perform the aforementioned operations. A system of one or more computers can be configured to perform particular actions by virtue of having software, firmware, hardware, or a combination of them installed on the system that in operation causes or cause the system to perform the aforementioned operations. One or more computer programs can be configured to perform particular actions by virtue of including instructions that, when executed by data processing apparatus, cause the apparatus to perform the aforementioned operations.

The foregoing and other embodiments can each optionally include one or more of the following features, alone or in combination. The operations may include segmenting a farmable region into one or more farmable zones based on one or more of a yield map, stability map, soil survey map, satellite map, and elevation map, and determining agronomic inputs for each of the one or more farmable zones. The operations may include merging a first farmable zone of the one or more farmable zones and a second farmable zone of the one or more farmable zones based on the determined agronomic inputs. The inferred agronomic characteristic may be for the farmable zone, and the operations may include extrapolating the inferred agronomic characteristic for the farmable zone to a geographic area, the geographic area being larger than the farmable zone. The extrapolation may be based, at least in part, on a measure of similarity between a historic crop yield in the farmable zone and a historic crop yield in the geographic area. The agronomic inputs may include at least one of a water agronomic input, a nitrogen agronomic input, and a water and nitrogen agronomic input representative of weather conditions over a growing season.

In general, another innovative aspect of the subject matter described in this specification can be embodied in a data processing apparatus for processing data records representative of an input set of agronomic inputs. The data processing apparatus includes one or more processing devices and one or more machine-readable hardware storage devices comprising instructions that are executable by the one or more processing devices to cause the one or more processing devices to perform operations. The operations include accessing, from a database, data records including collected data representing reference agronomic inputs and one or more reference agronomic outputs of a farmable zone. The operations include obtaining an input set of reference agronomic inputs from the collected data. The operations include predicting each agronomic output of an output set using an agronomic simulator and the input set. The operations include using a metaheuristic to determine scores for the input set comprising scoring the saliency of the output set as a function of the one or more reference agronomic outputs, and determining the scores for the input set based on the scored saliency of the output set. The operations include inferring an agronomic input based on the scores of the input set.

Other embodiments of this aspect include corresponding methods, computer systems, and computer programs recorded on one or more computer storage devices, each configured to perform the aforementioned operations. A system of one or more computers can be configured to perform particular actions by virtue of having software, firmware, hardware, or a combination of them installed on the system that in operation causes or cause the system to perform the aforementioned operations. One or more computer programs can be configured to perform particular actions by virtue of including instructions that, when executed by data processing apparatus, cause the apparatus to perform the aforementioned operations.

The foregoing and other embodiments can each optionally include one or more of the following features, alone or in combination. The operations may include selecting a metaheuristic from a list comprising a Markov chain Monte Carlo model, an approximate Bayesian computation model, a trans-dimensional Markov chain Monte Carlo model, a simulated annealing model, a neural network, a particle swarm optimization model, or a simultaneous perturbation stochastic approximation model. Using a metaheuristic may include applying a scoring function to the output set and to the one or more reference agronomic outputs, the scoring function comparing the output set to the one or more reference agronomic outputs, adjusting the input set of reference agronomic inputs based on the scoring function, and providing the adjusted input set to the agronomic simulator to determine an updated output set. The operations may include identifying a set of agronomic inputs that are responsive to an intervention, updating at least one agronomic input in the set consistent with an effect of applying at least one intervention, using the agronomic simulator to predict an updated agronomic output using the updated at least one agronomic input, and in response to determining that the updated agronomic output represents an improvement over the agronomic output in the output set, causing transformation of one or more characteristics of the farmable zone. The data processing apparatus may include a system for transforming at least one of soil conditions and agronomic practices of the farmable zone by applying the intervention. The operations may include identifying a subset of the input set based a sensitivity of the agronomic output to the agronomic inputs in the input set, and using the subset as the input set of reference agronomic inputs. The operations may include identifying a subset of the input set based on a cost associated with altering an agronomic input in the input set to affect the agronomic output, and using the subset as the input set of reference agronomic inputs.

In general, another innovative aspect of the subject matter described in this specification can be embodied in a method performed by a data processing apparatus for processing data records representative of an input set of agronomic inputs to infer a value of an agronomic input. The actions of the method include accessing, from a database, data records including collected data representing reference agronomic inputs and one or more reference agronomic outputs of a farmable zone. The actions of the method include obtaining an input set of reference agronomic inputs from the collected data. The actions of the method include predicting each agronomic output of an output set using an agronomic simulator and the input set. The actions of the method include using a metaheuristic to determine scores for the input set comprising scoring the saliency of the output set as a function of the one or more reference agronomic outputs, and determining the scores for the input set based, at least in part, on the scored saliency of the output set. The actions of the method include inferring an agronomic input based, at least in part, on the scores of the input set.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. The actions of the method may include selecting a metaheuristic from a list comprising a Markov chain Monte Carlo model, an approximate Bayesian computation model, a trans-dimensional Markov chain Monte Carlo model, a simulated annealing model, a neural network, a particle swarm optimization model, or a simultaneous perturbation stochastic approximation model. The actions of using a metaheuristic may include applying a scoring function to the output set and to the one or more reference agronomic outputs, the scoring function comparing the output set to the one or more reference agronomic outputs, adjusting the input set of reference agronomic inputs based on the scoring function, and providing the adjusted input set to the agronomic simulator to determine an updated output set. The actions of the method may include identifying a set of agronomic inputs that are responsive to an intervention, updating at least one agronomic input in the set consistent with an effect of applying at least one intervention, using the agronomic simulator to predict an updated agronomic output using the updated at least one agronomic input, and in response to determining that the updated agronomic output represents an improvement over the agronomic output in the output set, causing transformation of one or more characteristics of the farmable zone. The actions of the method may include using a system for transforming at least one of soil conditions and agronomic practices of the farmable zone by applying the intervention. The actions of the method may include identifying a subset of the input set based a sensitivity of the agronomic output to the agronomic inputs in the input set, and using the subset as the input set of reference agronomic inputs. The actions of the method may include identifying a subset of the input set based a cost associated with altering an agronomic input in the input set to affect the agronomic output, and using the subset as the input set of reference agronomic inputs.

In general, another innovative aspect of the subject matter described in this specification can be embodied in a system that includes one or more sensors for collecting data indicative of reference agronomic inputs and a reference agronomic output of one or more farmable zones. The system includes one or more processing devices. The system also includes one or more machine-readable hardware storage devices comprising instructions that are executable by the one or more processing devices to cause the one or more processing devices to perform operations that include accessing, from the one or more sensors, collected data. The operations include parsing the collected data to identify the reference agronomic inputs. The operations include obtaining an input set of one or more of the reference agronomic inputs. The operations include generating data indicative of a prediction of each agronomic output of an output set using an agronomic simulator and the input set. The operations include using a metaheuristic to determine scores for the input set comprising scoring the saliency of the output set as a function of the one or more reference agronomic outputs, and determining the scores of the input set based on the scored saliency. The operations include generating updated agronomic inputs based on the scores of the input set. The operations also include causing transformation of one or more soil conditions based on the updated agronomic inputs.

In general, another innovative aspect of the subject matter described in this specification can be embodied in methods for processing data records representative of an input set of agronomic inputs to infer a value of an agronomic input. One of the methods includes the act of accessing, from a data storage device, data records including collected data representing reference agronomic inputs and one or more reference agronomic outputs of a farmable zone. The method includes the act of obtaining an input set of reference agronomic inputs from the collected data. The method includes the act of predicting each agronomic output of an output set using an agronomic simulator and the input set. The method includes the act of using a metaheuristic to determine scores for the input set including scoring the saliency of the output set as a function of the one or more reference agronomic outputs and determining the scores for the input set based on the scored saliency of the output set. The method also includes the act of inferring an agronomic input based on the scores of the input set.

In general, another innovative aspect of the subject matter described in this specification can be embodied in methods for improving a farmable zone. One of the methods includes the act of identifying a farmable zone. The method includes the act of using an agronomic simulator to determine at least one agronomic input for the farmable zone. The method includes the act of comparing the information obtained for the at least one agronomic input with a corresponding reference input. The method includes the act of selecting at least one agronomic characteristic to modify based on the comparing. The method includes the act of transmitting instructions to modify the at least one agronomic characteristic thereby improving an agronomic output of the farmable zone, relative to agronomic output of the farmable zone independent of modification of the at least one agronomic input.

In general, another innovative aspect of the subject matter described in this specification can be embodied in methods for providing a farm development plan to a farm agent. One of the methods includes the act of identifying a farmable zone. The method includes the act of obtaining information for a plurality of agronomic inputs from within the farmable zone. The method includes the act of analyzing the information obtained for the plurality of agronomic inputs with a relationship model. The method includes the act of determining, from the analysis, preferred values for the plurality of agronomic inputs. The method also includes the act of transmitting instructions to the farm agent for implementing the preferred values for the plurality of agronomic inputs, thereby providing a farm development plan to the farm agent.

In general, another innovative aspect of the subject matter described in this specification can be embodied in methods for processing data records to infer an agronomic characteristic, the data records representative of an input set of agronomic inputs. One of the methods includes accessing, from a data storage device, data records including collected data representing reference agronomic inputs and a reference agronomic output of farmable zone. The method includes the act of obtaining an input set of agronomic inputs based on the reference agronomic inputs, the input set including a potential value for the agronomic characteristic. The method includes the act of iteratively applying the input set of agronomic inputs to an agronomic simulator, each iteration comprising predicting agronomic outputs using the agronomic simulator processing the input set, determining an error score by applying an error function of predicted agronomic outputs and the one or more reference agronomic outputs, in response to determining that the error score is greater than a threshold value, adjusting the agronomic inputs in the input set, and in response to determining that the error score is less than or equal to the threshold value, ending the iterations. The method also includes the act of inferring the agronomic characteristic based on the input set of a final iteration.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. The methods may include the act of using the metaheuristic to generate a plurality of alternative values for the input set. Predicting each agronomic output of the output set may include varying values of the input set, and simulating additional agronomic outputs using the agronomic simulator and the varying values. Varying values of the input set may be based on a sensitivity of at least one agronomic output in the output set to a value of an agronomic input of the input set. The methods may include the acts of identifying a set of agronomic inputs that may be responsive to an intervention, updating at least one agronomic input in the set consistent with an effect of applying at least one intervention, using the agronomic simulator to predict an updated agronomic output using the updated at least one agronomic input, and in response to determining that the second agronomic output represents an improvement over the agronomic output in the output set, generating a report identifying the intervention. The methods may include the acts of identifying a set of agronomic inputs that are responsive to an intervention, updating at least one agronomic input in the set consistent with an effect of altering at least one intervention, using the agronomic simulator to predict an updated agronomic output using the updated at least one agronomic input, and in response to determining that the second agronomic output is within a threshold value of the agronomic output in the output set, generating a report identifying the alteration to the intervention. Determining that the second agronomic output represents an improvement over the agronomic output in the output set may include determining that the second agronomic output may be greater than the agronomic output in the output set. Determining that the second agronomic output represents an improvement over the agronomic output in the output set may include determining that the second agronomic output may be less than the agronomic output in the output set. The methods may include the act of transforming at least one of soil conditions and agronomic practices of the farmable zone by applying the intervention. The methods may include the act of identifying a subset of the input set based on threshold values and using the subset as the input set of reference agronomic inputs. The methods may include the act of identifying a subset of the input set based the sensitivity of the agronomic output to the agronomic inputs in the input set, and using the subset as the input set of reference agronomic inputs. The methods may include the acts of identifying a subset of the input set based a cost associated with altering an agronomic input in the input set to affect the agronomic output and using the subset as the input set of reference agronomic inputs. Using a metaheuristic may include applying an error function to the output set and the one or more reference agronomic outputs, the error function comparing the output set of agronomic output to the one or more reference agronomic outputs, adjusting the input set of agronomic inputs based on results of the application of the error function, and providing the adjusted input set to the agronomic simulator to determine an updated output set. The methods may include the act of adjusting at least one of the agronomic inputs in the input set based on a comparison of the updated output set and the one or more reference agronomic outputs. For example, the error function to assess the fit between the output set of agronomic output and the reference agronomic outputs could comprise calculating the difference between the output and reference output values and scoring this difference by computing the probability of that deviance assuming a Gaussian distribution of errors to provide a score for the saliency of the outputs of the current agronomic input values. Continuing the example, a metaheuristic such as Metropolis-Hastings could be used to propose updated random values of the input set of agronomic inputs, producing an updated set of agronomic outputs using the agronomic simulator, additionally scoring these updated outputs using the aforementioned error function, and deciding to accept the proposed updated set of agronomic inputs if the saliency score of the associated outputs is better than the current score, or sometimes by chance following the Metropolis-Hastings rule so as to eventually explore more of the search space of input agronomic parameter values.

The methods may include the act of determining to adjust a first agronomic input of the input set based on adjusting a second agronomic input of the input set, wherein the first agronomic input may be at least partially dependent on the second agronomic input. The methods may include the acts of segmenting a farmable region into one or more farmable zones based on one or more of a yield map, stability map, soil survey map, satellite map, and elevation map and determining agronomic inputs for each of the one or more farmable zones. The methods may include the act of merging a first farmable zone of the one or more farmable zones and a second farmable zone of the one or more farmable zones based on the determined agronomic inputs. The methods may include the act of separating a first farmable zone of the one or more farmable zones into a second farmable zone and a third farmable zones based on the determined agronomic inputs. The methods may include the act of generating a report of the inferred agronomic input of the farmable zone. The methods may include the act of extrapolating the inferred agronomic input of the farmable zone to a geographic area, the geographic area being larger than the farmable zone. The extrapolation may be based, at least in part, on a measure of similarity between a historic crop yield in the farmable zone and a historic crop yield in the geographic area. An agronomic output of the output set may include at least one of a normalized difference vegetation index, leaf area index, a crop yield, and a measure of sustainability. The reference agronomic inputs may be selected from the group consisting of environmental characteristics and agronomic characteristics. The one or more reference agronomic outputs may include crop yield data. The methods may include the act of selecting a metaheuristic from the list consisting of a Markov chain Monte Carlo model, an approximate Bayesian computation model, and a trans-dimensional Markov chain Monte Carlo model. The method may include the act of selecting a metaheuristic from the list consisting of a Simulated Annealing, Neural Network, Particle Swarm Optimization, and a Simultaneous Perturbation Stochastic Approximation model. The agronomic inputs may include at least one of a water deficit agronomic input, a nitrogen deficit agronomic input, and a water and nitrogen deficit agronomic input. The methods may include the act of geolocating, based on GPS data received from a GPS receiver in a device, one or more plants. Improving an agronomic output may include increasing the agronomic output relative to the agronomic output of the farmable zone independent of modification of the at least one agronomic input. Improving an agronomic output may include decreasing the agronomic output relative to agronomic output of the farmable zone independent of modification of the at least one agronomic input. The methods may include the act of modifying the at least one agronomic characteristic for the farmable zone. The farmable zone may be identified using one or more of GPS coordinates, a yield map, a stability map, a survey map, an elevation map, and a water table map. The at least one agronomic input may be selected from the group consisting of soil condition data, weather condition data, crop plant data, and farming practice data. The methods may include the act of obtaining the information for the at least one agronomic input using at least one of imagery, genetic analysis, chemical analysis, one or more historical records, one or more contemporary records, one or more predictions, one or more indices, and one or more charts. The instructions to modify the at least one agronomic input may include at least one of instructions to modify one or more soil conditions, instructions to modify the selection of crop plant, variety, cultivar, or accession; and instructions to modify one or more farming practices. The one or more farming practices may include at least one of spraying fungicides, spraying pesticides, spraying nucleic acids, spraying antimicrobials, and spraying biologicals.

Particular embodiments of the subject matter described in this specification can be implemented so as to realize one or more of the following advantages. Agronomic inputs can be determined with a high degree of accuracy. Customized intervention plans can be created to minimize waste. Agronomic output (such as crop yield) can be increased. Simulations can be performed using fewer computational resources.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a diagram of an example of a system for obtaining agronomic data.

FIG. 1B illustrates components that describe agronomic characteristics of a farmable zone.

FIG. 2 illustrates providing agronomic inputs to agronomic simulator to determine agronomic outputs.

FIG. 3 illustrates a system for determining agronomic and environmental characteristics of a farmable zone.

FIG. 4 is a flowchart of an example process for determining agronomic characteristics of a farmable zone.

FIG. 5 is an example of a process for adjusting agronomic inputs based on a selected intervention.

FIG. 6 illustrates a flow chart of a process to increase agronomic output.

FIG. 7 illustrates segmenting a farmable region into farmable zones.

FIG. 8 illustrates an example of combining farmable zones based on agronomic characteristics.

FIG. 9 illustrates assigning agronomic characteristics to a larger geographic area based on a farmable zone.

Like reference numbers and designations in the various drawings indicate like elements.

### DETAILED DESCRIPTION

The following terms may be used in the detailed description:

As used herein, an agronomic input refers to one or more agricultural and/or environmental characteristics related to the producing and using of plants for food, feed, fiber, fuel, ornamentation or environmental or climatic modification. Environmental characteristics refer to climate, weather conditions, and soil conditions, while agriculture characteristics refer to cultivars and activities performed in the process of farming.

As used herein, an agronomic output refers to a result of agronomic activity related to the agronomic inputs.

As used herein, an agronomic simulator refers to a system that estimates and/or predicts an output related to producing and using plants for food, feed, fuel, fiber, ornamentation or environmental or climatic modification.

As used herein, a relationship model refers to a model that determines a measure of relationship between a reference agronomic output and a simulated agronomic output.

As used herein, a farmable region refers to an area for which agronomic inputs are going to be determined.

As used herein a farmable zone refers to an area of a farmable region that shares common values for at least one agronomic input.

As used herein an input set refers to a set of agronomic inputs that can be provided as input to the agronomic simulator.

As used herein an intervention refers to an action that can be taken in the real world to affect one or more of the agronomic and/or environmental characteristics.

As used herein a metaheuristic refers to a procedure applying a relationship model that may provide a sufficiently good solution to an optimization problem.

As used herein an output set refers to one or more agronomic outputs from an agronomic simulator.

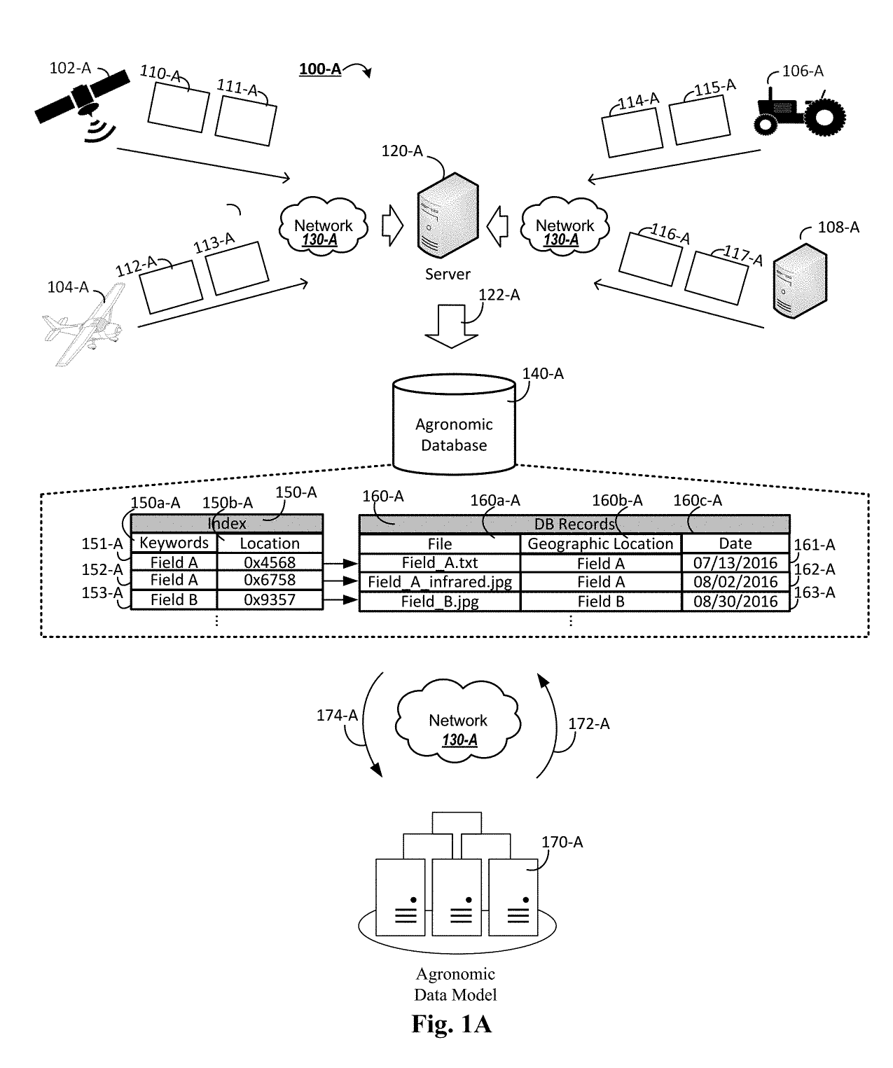

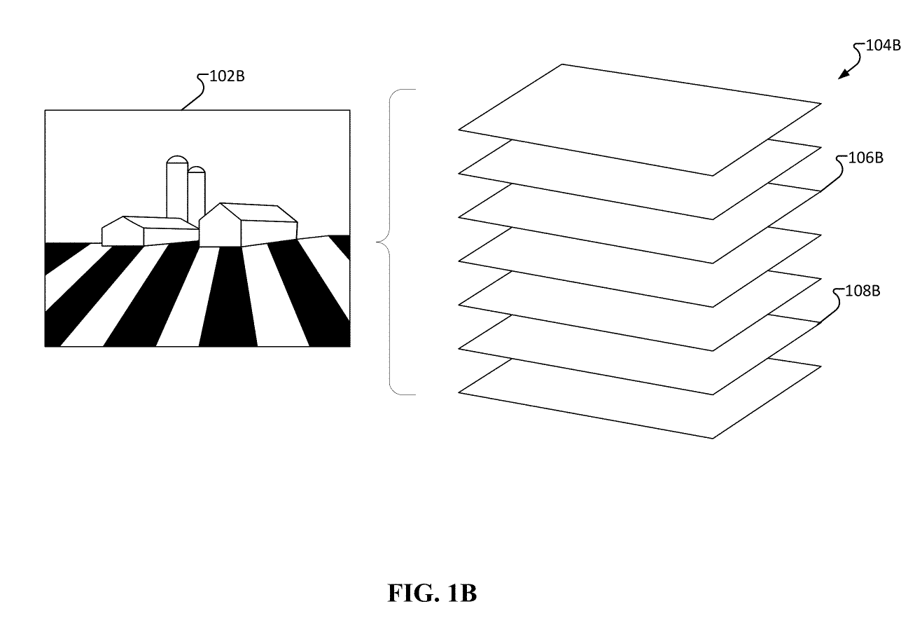

FIG. 1A is a diagram of an example of a system 100-A for obtaining agronomic data. The system 100-A includes at least one or more vehicles such as a satellite 102-A, an airplane 104-A, or a tractor 106-A, at least one agronomic data providing server 108-A, a server 120-A, an agronomic database 140-A, and an agronomic data model 170-A.

Each of the one or more vehicles may be equipped with one or more sensors that are capable of collecting agronomic data associated with a particular geographic region such as a field of a farm. In some instances, the vehicles may include, for example, vehicles such as a satellite 102-A or an airplane 104-A equipped with one or more remote sensing devices for capturing an image of at least a portion of a geographic location. The image may include, for example, red-blue-green images, thermal images, infrared images, radar images, or the like. Alternatively, or in addition, the vehicles may include a tractor 106-A that is equipped with one or more sensors capable of collecting agronomic data related to a particular portion of a geographic location that includes, for example, a plant's location (e.g., GPS location), the plant's weight, the plant's time of harvest, and the like. Other types of vehicles may also be used to collect agronomic data associated with a particular portion of a geographic location. Such vehicles may include, for example, a drone. The agronomic data 110-A, 111-A, 112A, 113-A, 114A, and 115A captured each of the respective vehicles may be transmitted via a network 103-A to a server 120-A. The network 103-A may include one, or multiple, networks such as a LAN, a WAN, a cellular network, the Internet, or the like.

Alternatively, or in addition, agronomic data may be obtained from one or more agronomic data providing servers such as server 108-A. The server 108-A may, for example, house a database of historic agronomic data items from one or more geographic locations. For instance, the server 108-A may be a database hosted by a government agency, university, or the like that tracks changes in agronomic data associated with particular geographic locations over time. The agronomic data 116-A, 117-A may be obtained from the server 108-A via a network 130-A

Server 120-A may process the data 110-A, 111-A, 112-A, 113-A, 114-A, 115-A, 116-A, 117-A received via network 130-A and store 122-A the received data in an agronomic database 140-A. Processing the received data 110-A, 111-A, 112-A, 113-A, 114-A, 115-A, 116-A, 117-A by server 120-A may include extracting relevant aspects of the received data for storage. Alternatively, or in addition, processing of the received data 110-A, 111-A, 112-A, 113-A, 114-A, 115-A, 116-A, 117-A by server 120-A may also include generating an index 150-A that can be used to efficiently access and retrieve the data 110-A, 111-A, 112-A, 113-A, 114-A, 115-A, 116-A, 117-A once the data 110-A, 111-A, 112-A, 113-A, 114-A, 115-A, 116-A, 117-A is stored as a record in the 160-A in the agronomic database 140-A. The agronomic database 140-A may be hosted on the server 120-A. Alternatively, or in addition, the agronomic database may be hosted by one or more other servers.

The index 150-A may utilize a variety of different fields for each index entry 151-A, 152-A, 153-A, or the like. The index fields may include a variety of one or more fields such as, for example, a keyword fields 150a-A, a storage location field 150b-A, or the like. In the example of system 100-A, the agronomic database may be configured to receive one or more search parameters for one or more database records such as, for example, search parameters requesting data related to “Field A.” In response, to the receipt of such search parameters, the agronomic database 140-A may identify all the index entries including the search parameter “Field A,” obtain the storage location 150b-A associated with each index entry, and use the obtained storage locations to access the database record stored at each of the obtained storage locations. Though a particular example of an index 150-A and index fields 150a-A, 150b-B are provided herein, the present disclosure need not be so limited. Instead, any type of index may be used to index the data 110-A, 111-A, 112-A, 113-A, 114-A, 115-A, 116-A, 117-A received and stored in the agronomic database 140-A so long as the data stored in the agronomic database 140-A can be accessed by the agronomic data model 170-A.

The data 110-A, 111-A, 112-A, 113-A, 114-A, 115-A, 116-A, 117-A may be stored in the agronomic database 140-A as one or more database records 160-A. The agronomic database 140-A may store records in any logical database form such as, for example, a relational database, hierarchical database, column database, or the like. Instead of requiring the use of a particular logical database schema, the agronomic database 140-A may only require a configuration that allows the agronomic data stored by the agronomic database 140-A to be accessed by the agronomic data model 170-A. Examples of the types of data that may be stored in agronomic database 140-A may include, for example, a file 160a-A such as an image file, a geographic location associated with the stored file (or other agronomic data) 160b-A, a date 160c-A the data was captured, or the like. Other types of capture information may be stored, as necessary, based on type of received data 110-A, 111-A, 112-A, 113-A, 114-A, 115-A, 116-A, 117-A.

The agronomic data model 170-A may include one or more server computers. The agronomic data model 170-A may request 172-A data from the agronomic database 140-A via a network 130-A that can be used to analyze agronomic characteristics associated with a particular geographic location. Agronomic data responsive to the agronomic data model's 170-A request 172-A may be returned 174-A from the agronomic database 140-A to the agronomic data model 170-A via one or more networks 130-A. The agronomic data model 170-A may use the agronomic data returned 174-A from the agronomic database 140-A as an agronomic input to the model.

FIG. 1B illustrates components that describe agronomic characteristics of a farmable zone. In some implementations, the farmable region may be a traditional field, or a controlled or partially controlled environment such as a greenhouse, a glass house, a shade house or a growth chamber. The performance of the farmable zone 102B can be influenced by a large number of different agronomic and environmental characteristics. For example, crop yield can be affected by rainfall, soil depth, nitrogen levels, and plant population, among other things. Each of these characteristics can be viewed as a separate variable or layer. For example, the farmable zone 102B may be described by layers 104B, which include a nitrogen layer 106B and a rain fall layer 108B. Agronomic characteristics refer to environmental conditions related to the producing and using of plants for food, feed, fuel, fiber, ornamentation and environmental or climatic modification. Agronomic characteristics can include environmental characteristics (such as weather) and agricultural characteristics (such as soil nitrogen levels).

In general, if plant growth is different across a farmable region, the differences can be attributed to the differences in agronomic inputs. In this manner, plants can be used as biological sensors that indicate agronomic characteristics. Farm or remote sensing equipment can be equipped with global positioning system (GPS) devices, allowing the location of individual plants or groups of plants to be tracked.

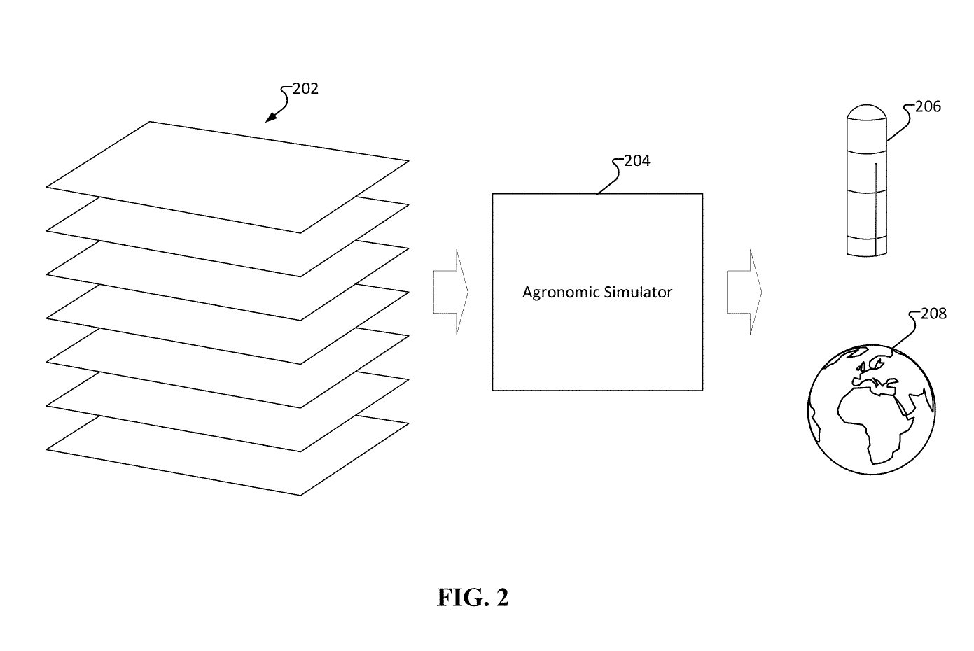

FIG. 2 illustrates providing agronomic inputs to agronomic simulator 204 to determine agronomic outputs. Agronomic characteristics 202 are provided as an agronomic input put into an agronomic simulator 204. In general, an agronomic simulator is a system that applies the agronomic inputs to an agronomic model to estimate and/or predict an agronomic output related to producing and using plants for food, feed, fuel, fiber, ornamentation, or environmental or climatic modification.

Agronomic inputs may include both a type of agronomic input (e.g. sandiness) and a value for the agronomic input (e.g. 20%). In general, a change in an agronomic input refers to a change in the value for the agronomic input. Examples of agronomic inputs can include, but are not limited to: maximum ponding height; soil layer depth; saturated soil water content; soil bulk density; soil organic carbon content; soil clay content; soil sand content; soil silt content; soil stones (coarse fragment) content; lower limit of soil water availability; drained upper limit of soil water availability; saturated soil hydraulic conductivity; soil nitrogen content; soil pH; soil cation exchange capacity; soil calcium carbonate content; soil fresh organic matter (FOM) carbon, nitrogen and phosphorus content; soil active inorganic carbon content; soil slow inorganic carbon content; soil active inorganic phosphorus content; soil slow inorganic phosphorus content; soil mineral nitrogen including nitrate, ammonia and urea; air temperatures (including minimum and/or maximum); soil temperatures (including minimum and/or maximum); storm intensity (tightness of precipitation in time, for example, 1″ over 5 hours or in 5 minutes); elevation, slipe and gradients of elevation; solar radiation; precipitation; relative humidity; planting date; planting window dates; temperate thresholds for planting; soil moisture thresholds for planting; crop row spacing; planting depth; crop species; crop variety/cultivar; yield components of the variety/cultivar (for example, beans per pod, pods per plant, kernels per ear, ears per plant, etc.); length of developmental stages of variety/cultivar; planting density; field irrigation; irrigation event water volume; irrigation event dates; irrigation drain depth; irrigation drain spacing; fertilizer date; fertilizer amount; fertilizer type (for example, manure, anhydrous ammonia, etc.); chemical composition of fertilizer type; fertilizer application depth; fertilizer incorporation percentage; harvest date; percent of stalk/leaves knocked down at harvest; percent of plant by-product harvested (leaves, etc.); percent of grain/fiber/fruit/etc. harvested.

Agronomic output may include both a type of agronomic output (e.g. crop yield) and a value for the agronomic output (e.g. 175 bushels/acre). In general, a change in an agronomic output refers to a change in the value for the agronomic output.

The agronomic outputs can be related to crop yield 206, however, the agronomic simulator 204 can also produce other outputs (for example, outputs related to sustainability, environmental impact 208, etc.). Examples of agronomic outputs can include, but are not limited to: length of developmental stages of variety/cultivar; yield; leaf area index (LAI) over time; damage/death to the crop by frost, anoxia, heat, drought, etc.; dry weight of grains/fiber/fruit/veg; dry weight of shoots/areal plant parts; root depth; total root dry weight; change in biomass from previous time slice; daily and accumulated thermal time; radiation use efficiency; relative thermal time to maturity; current plant development phase; root weight, and of tillers; grain weight, and of tillers; total accumulated leaves or their equivalents; total accumulated phylochron intervals; leaf weight, and of tillers; weight of stem reserves, and of tillers; weight of stems, and of tillers; sink weight; source weight; below ground active organic nitrogen, carbon, phosphorus; below ground active inorganic nitrogen, carbon, phosphorus; atmospheric CO2; below ground fertilizer nitrogen, carbon, phosphorus; carbon in cumulative CO2 evolved; cumulative nitrogen fixed; cumulative harvested plant nitrogen and phosphorus; total nitrogen, carbon, phosphorus additions; below ground labile nitrogen and phosphorus; net nitrogen, carbon, phosphorus change; total nitrogen, carbon, phosphorus withdrawals; cumulative plant uptake of nitrogen and phosphorus; above ground rapid FOM nitrogen, carbon, phosphorus; below ground rapid FOM nitrogen, carbon, phosphorus; below ground resistant organic nitrogen, carbon, phosphorus; above ground interim FOM carbon; below ground interim FOM carbon; above ground slow FOM nitrogen, carbon; below ground slow FOM nitrogen, carbon; below ground slow organic nitrogen, carbon; below ground slow inorganic nitrogen, carbon; below ground solution nitrogen, phosphate; recognizable standing dead nitrogen, carbon, phosphorus; total nitrogen that can volatize; inorganic nitrogen in soil; cumulative nitrogen leached; organic nitrogen in soil; total nitrogen volatized; cold stress; drought; drought in stomatal conductivity; drought in turgidity; heat stress; nitrogen stress; phosphorus stress; photoperiod factor; cumulative drainage; potential cumulative evapotranspiration; potential evapotranspiration daily; cumulative plant transpiration; plant transpiration daily; cumulative soil evaporation; soil evaporation daily; cumulative evapotranspiration; evapotranspiration daily; cumulative irrigation; ponding height current; ponding height maximum; cumulative precipitation; cumulative runoff; potentially extractable water; nitrogen leaching, carbon sequestration, greenhouse gasses emitted, and water table depth.

Agronomic inputs can be broken down by soil layer and over different time periods (for example, daily). For example, for every soil layer and for every time period agronomic outputs can also include: new bulk density; downward water flux; net water flow; inorganic nitrogen in soil; root water uptake; dry weight of roots in the layer; soil temp; soil water content; soil hydraulic conductivity; upward water flux; active, slow, resistant organic carbon content's rapid, intermediate, and slow; total fresh organic matter content; soil carbon content; CO₂ sequestration; active, slow and resistant organic nitrogen contents; ammonia content; N₂0 content; nitrogen content; urea content.

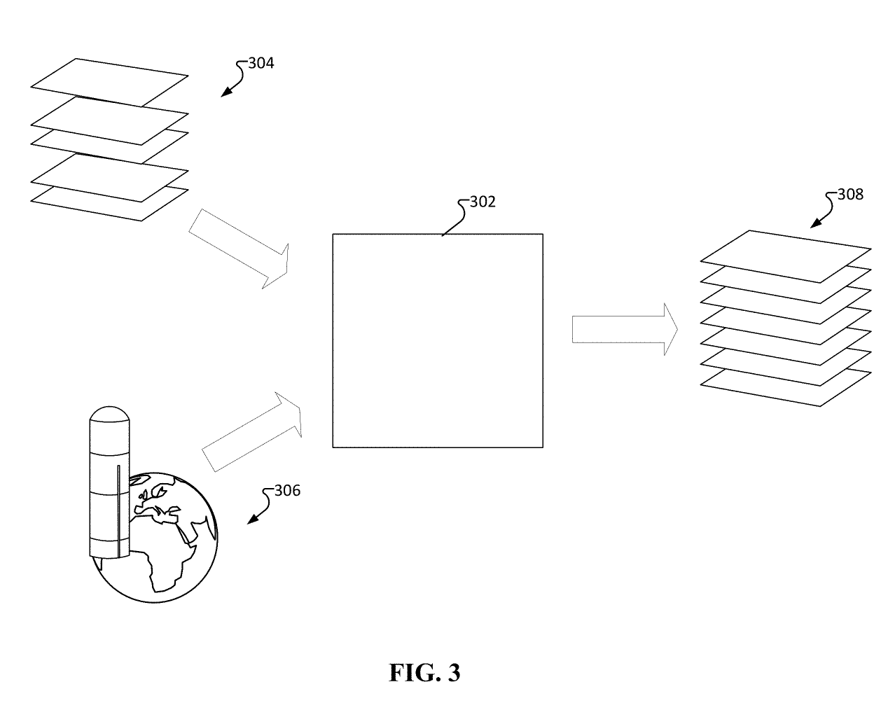

FIG. 3 illustrates a system for determining agronomic and environmental characteristics of a farmable zone. The system 302 accepts some agronomic characteristics of the farmable zone as agronomic inputs 304. These agronomic inputs 304 may be incomplete or inaccurate, but can provide a starting point for analysis. In some implementations, the agronomic inputs may be assumed values based on available data, expert knowledge, or common practice. In some implementations, the agronomic inputs may be measured (for example, by using sensors) or reported data. The system 302 also accepts reference agronomic outputs 306 associated with the farmable zone. For example, the system 302 may accept the historic crop yield over one or more years.

The agronomic inputs and observed agronomic output may be collected from one or more sensors. The sensor may include GPS or other location data. In some implementations, observed agronomic outputs may be received from harvesting or farming equipment equipped with GPS tracking and harvest measurement information. In some implementations, observed agronomic outputs may be received from soil sensors or other sensors that measure soil and/or weather conditions. In some implementations, individual plants may be located using GPS tracking information. In some implementations, observed agronomic inputs and/or outputs may be received from remote sensors such as those mounted on satellites or aerial devices. In some implementations, the modalities of the remote sensors may include thermal, visible light, near-infrared, ultraviolet and other forms of electromagnetic radiation. In some implementations, the modalities of the remote sensors may include active sensing such as LIDAR, RADAR or X-ray imaging. In some implementations, the modalities of the remote sensors may include advanced imaging systems such as acoustic tomography, CT, MRI, or PET.

Reference agronomic inputs may be unavailable or undesirable. In some implementations, inputs may be assumed from data from surveys, historical practices or records, farmer's almanacs, or computed best or discounted best practices for a field. In some implementations, weather conditions for a period of time (such as a growing season) may be aggregated and combined into aggregate agronomic inputs. For example, a water deficit agronomic input and/or a nitrogen deficit agronomic input (or a combined a water deficit and nitrogen deficit agronomic input) may be representative of weather conditions over a growing season. A water deficit may be a measure of how much less water the farmable zone received than is typical for the farmable zone. A nitrogen deficit may be a measure of how much less nitrogen is available to the plants as compared to an amount that is typically available for the farmable zone. Treating the variable weather conditions over a period of time as an aggregate enables efficient processing of weather conditions and improves the computational efficiency of the process.

In some implementations, the observed agronomic output may include data that has been collected over a period of time. For example, the agronomic output may include a mean and standard deviation of crop yield over a number of years. Using multiple data points over a number of years helps to insulate the data from random spikes in values that are not illustrative of normal conditions. In another example, plant canopy area may be collected over a number of days of a growing season.

The system uses the provided agronomic inputs 304 and the observed agronomic outputs 306 to determine a set of likely agronomic inputs 308. The agronomic inputs 308 are consistent with the observed agronomic outputs 306. That is, an agronomic model indicates that a farmable zone having the set of agronomic inputs 308 could produce the observed agronomic outputs 306. These agronomic inputs 308 more accurately reflect the actual agronomic characteristics of the farmable zone.

Agronomic inputs of a farmable zone can be determined using different metaheuristic techniques, such as a Markov chain Monte Carlo (MCMC) and approximate Bayesian computations or Simulated Annealing. Other metaheuristics can include genetic algorithms, differential evolution, particle swarm optimization, ant colony algorithms, tabu search, stochastic gradient ascent/descent, simultaneous perturbation stochastic approximation (SPSA), Differential Evolution Adaptive Metropolis (DREAM), and Hamiltonian MCMC. These methods enable the solution of optimization problems in large dimensional spaces, as discussed further below.

Determining the set of agronomic inputs can be an iterative process that tries different combinations of agronomic inputs and different values for each agronomic input. In general, adjusting agronomic inputs refers to adjusting which agronomic inputs are being evaluated (for example, sandiness, nitrogen level) and/or adjusting the values for particular agronomic inputs (for example, 20% sandiness to 30% sandiness).

The meta-heuristic can be used, for example, to generate multiple different alternative values for the agronomic inputs. In some implementations, the metaheuristic used can be simply enumerating all possible values, or a gridded set of values, of the input agronomic characteristics. Another metaheuristic mechanism may be performing a random search of a number of possible values of the input agronomic characteristics.

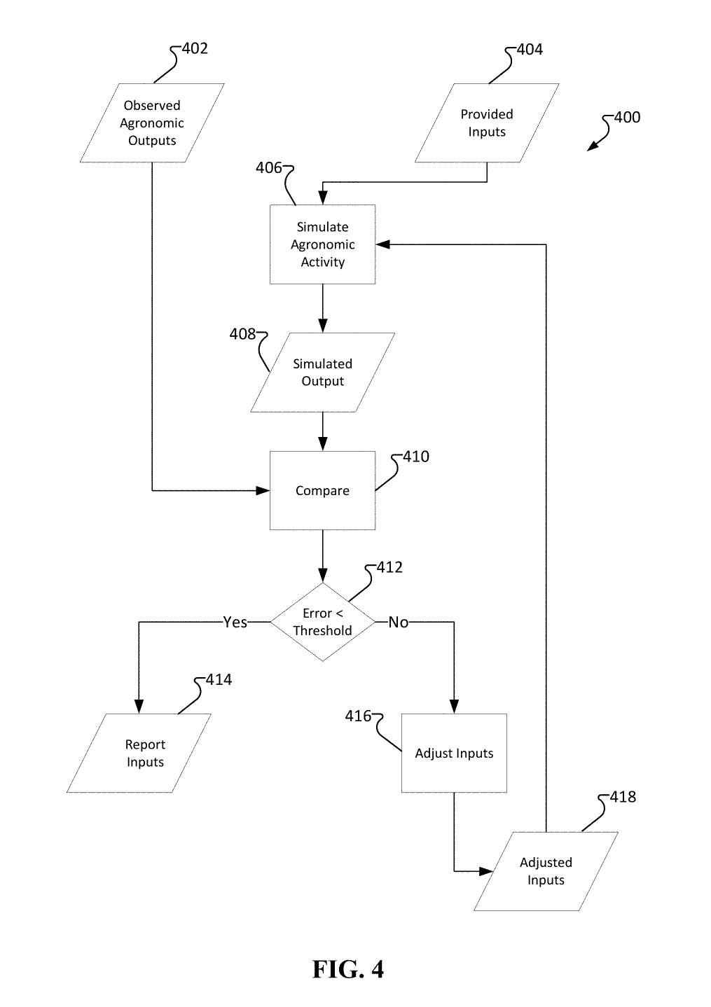

FIG. 4 is a flowchart of an example process 400 for determining agronomic characteristics of a farmable zone. The process 400 accepts provided agronomic characteristics 404 as an input. The agronomic characteristics 404 may be provided by taking soil samples, recent weather conditions, common practice, a soil survey, or any other means of obtaining agronomic characteristic (as described above). The agronomic characteristics 404 may be stored in one or more data storage devices.

The process simulates agronomic activity 406 based on the provided agronomic inputs. The agronomic activity can be simulated using an agronomic model, such as the SYSTEM APPROACH TO LAND USE SUSTAINABILITY (SALUS) model or the CERES model.

The SALUS model can model continuous crop, soil, water, and nutrient conditions under different management strategies for multiple years. These strategies may have various crop rotations, planting dates, plant populations, irrigation and fertilizer applications, and tillage regimes. The model can simulate plant growth and soil conditions every day (during growing seasons and fallow periods) for any time period when weather sequences are available or assumed. The model can account for farming and management practices such as tillage and residues, water balance, soil organic matter, nitrogen and phosphorous dynamics, heat balance, plant growth, plant development, presence of biotech traits, application of fungicides, application of pesticides, application of antimicrobials, application of nucleic acids, and application of biologicals. The water balance can consider surface runoff, infiltration, surface evaporation, saturated and unsaturated soil water flow, drainage, root water uptake, soil evaporation and transpiration. The soil organic matter and nutrient model can simulate organic matter decomposition, nitrogen mineralization and formation of ammonium and nitrate, nitrogen immobilization, gaseous nitrogen losses, and three pools of phosphorous.

The process can use any agronomic simulator/model that can predict the agronomic outputs based on the provided agronomic inputs. This could include a physical, generative or mechanistic model; a purely statistical or machine learning model; or a hybrid. This could include a model which predicts agronomic outputs by attempting to match (by exact match or approximate match using, for instance, nearest neighbor) the provided agronomic inputs, or a transformation or function there of (such as a dimensionality reduction, such as Principle Components Analysis or the outputs of an Indian Buffet Process or other latent factor model), with a collection of previously observed inputs and their matching outputs and predicting the output of the matched input.

In some implementations, an agronomic simulator/model may include one or more non-analytic functions. An analytic function is a function that can be locally represented by a convergent power series. Consequently, a non-analytic function is a function that cannot be locally represented by a convergent power series. For instance, a non-analytic function may be piecewise defined, or it may use mathematical operators such as modulus or computer programming or logical operators such as if/then, loops, and value mappings that render the function non-analytical.

The simulation predicts agronomic outputs based on the provided agronomic inputs.

The process 400 takes the simulated output 408 of the simulation and compares 410 the simulated output 408 to the observed agronomic outputs 402. For example, the process 400 may apply an error function to the simulated output 408 and the observed output 402. In some implementations, the process 400 may compute a measure of similarity using the simulated output 408 and the observed output 402. For example, the system may compute the probability both outputs were generated from the same stochastic model. In some implementations, the process 400 may run additional simulations to provide context to the agronomic output. As discussed further below, the system can obtain agronomic outputs under conditions that assume unlimited resources (such as unlimited water and/or nitrogen). These special case agronomic outputs can be used to determine which agronomic inputs are incorrect. For example, if the special case agronomic outputs using unlimited water indicate a crop yield that is below an observed crop yield, the agronomic input that indicates the sandiness of the soil is incorrect (for example, the soil must be retaining more water than the type of soil described by the inputs can retain). In some implementations, the error may include an indication of residual agronomic inputs.

The process 400 compares the error to a threshold 412. The error can be used to determine the saliency of the agronomic inputs. If the error exceeds the threshold then the process 400 adjusts the inputs 416. The inputs may be adjusted based on the sensitivity of an agronomic output to the inputs. For example, to change a particular agronomic output it may require a large change in one agronomic input or a smaller change to a second agronomic input. The system may prefer, for example, to make smaller changes rather than a larger changes, thus improving the computational efficiency of the system. In some implementations, the sensitivity of an agronomic output to an agronomic input may vary depending on the value of the agronomic input. For example, crop yield may increase with the addition of nitrogen up until the point where the plants have all the nitrogen they can use. Additional nitrogen would not further change the crop yield. The inputs may also be adjusted based on the cost associated with modifying the agronomic input. For example, a lower cost change to an agronomic input may be preferred to a more expensive one. This factor may be used in circumstances where the process is being used to improve one or more agronomic outputs, as discussed further below. The system can be used to identify an improved combination of agronomic inputs that can produce the same agronomic output (or the same agronomic input within a predetermined threshold). For example, a farm agent may be applying 250 lbs. of nitrogen to a farm. In this example, excess nitrogen over 200 lbs. is both a waste of money and an environmental pollutant. If the agronomic simulator is not measuring nitrogen run-off or leeching but only crop yield, the system can still identify that the same agronomic output can be obtained by lowering the amount of nitrogen applied to the farmable zone.

The adjusted inputs 418 are used to re-simulate the agronomic activity 406. The error, for example may be a number of standard deviations from the expected value. In some implementations, the error is replaced with a similarity measure.

Not all agronomic inputs are equally likely. The agronomic inputs may be adjusted in the course of using a metaheuristic. For example, the system may determine a probability that the soil is sandier or less sandy. In some implementations, this probability may be independent of observed data or observed data for the farmable zone or region under consideration. These probabilities can be used to adjust, prioritize or disqualify some or all of the inputs. In this manner, inputs that cannot possibly occur are eliminated from the possible set of inputs, thereby improving the computational efficiency of the process. In some implementations, possibilities below a threshold may be eliminated from the possible set of inputs. In some implementations, possible inputs can be tried in proportion to their probability so as to probabilistically exclude some low probability inputs. In some implementations, given or previous inputs may be modified using the value of the input and a probability distribution of possible input values, for example by using a Bayesian update to produce a posterior value or distribution of the input. The direction of the adjustment can be determined based on an analysis between the observed agronomic outputs 402 and the simulated output 408. For example, if the crop yield is higher in the observed agronomic output than in the simulated agronomic output then any change (e.g. an increase) to the nitrogen levels of the soil would be in the positive direction (as less nitrogen would reduce the crop yield). In implementations in which the error includes an indication of residuals, the residuals can be used in the selection of the adjustments to the agronomic inputs. By limiting the input set of agronomic inputs that are more likely, and thereby eliminating combinations of agronomic inputs that are highly unlikely or impossible, the computational efficiency of the process 400 is improved. That is, the process 400 can identify agronomic inputs consistent with the observed agronomic output using less memory and processing power.

In some implementations, inputs may be dependent on one another. Changing one input may cause a change to another input. Alternatively, changing one input may not make sense or be likely without a change to another input. These dependencies may be stochastic, where given that certain sets of variables are highly correlated in the real world, when proposing a value of a first agronomic input it is necessary to propose a value of a second agronomic input which is sufficiently correlated with said first value as to result in proposing a realistic pair. For example, changing layer depth can result in a change to bulk density, which in turn may result in a change to saturated soil water content. These relationships may continue in this way so as to form a chain or web of correlated dependencies.

If the error does not exceed the threshold, then the agronomic inputs are identified as agronomic inputs that are consistent with the observed agronomic output. A report 414 may be generated that describes the identified agronomic inputs (characteristics) of the farmable zone. Alternatively, no threshold may be used (equivalent to a threshold of zero) and a sampling of possible inputs may be derived from use of the metaheuristic. This sampling may be analyzed to find the set of agronomic inputs (and their values) with corresponding outputs with the highest similarity or lowest error. The sampling may also be summarized to produce a measure of certainty or risk. For example, if a plurality of different values of a subset of the predicted agronomic inputs produce similar errors or similarity to the observed agronomic outputs, one can conclude that there is high uncertainty about the actual values of those inputs. One can also conclude that we have insufficient or insufficiently stratified data to recover the true values of those inputs with certainty. In some implementations, this measure of uncertainty is carried forward into downstream analyses, for instance to attenuate farmer recommendations of adjusting another agronomic input in light of this uncertainty. For instance, if this system produces a plurality of possible soil sandiness values with similar error scores, the system might recommend applying less nitrogen than in a more certain case, as there is some chance the soil is more sandy than expected and can hold less applied nitrogen.

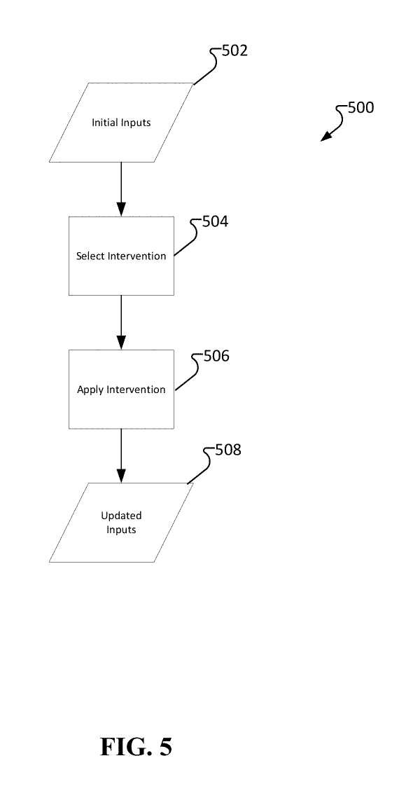

FIG. 5 is an example of a process 500 for adjusting agronomic inputs based on a selected intervention. The intervention may be a one-time event (applying fertilizer at a particular point), a repeating event (application of fertilizer or irrigation on a schedule), or a continuous event (the application of an irrigation system). The intervention may also be in the form of a policy where the specific action (fertilizing) or a parameter of the action (amount of fertilizer to apply) is a function of other agronomic or environmental parameters (e.g., apply fertilizer if the soil water content is not above 85% of the saturated soil water content or apply fertilizer of 50 lbs./acre plus an additional 1 pound for each pound lost due to leaching since the fall application as calculated by the agronomic simulator).

The process accepts initial inputs 502. The initial inputs may be, for example, inputs determined using the process 400 described above, or may be other agronomic inputs identified using another mechanism, such as a physical analysis of the soil.

The process 500 selected an intervention 504. The selected intervention may be provided by a user, or by another system. In some implementations, the process 500 may be provided a goal (for example, increase water). The process 500 may select an intervention that is likely to meet the goal (for example, irrigation). In some implementations, this goal may include functions, thresholds or targets of any or all of: environmental sustainability metrics, nitrogen leaching, greenhouse gas emissions, residual nitrogen, nitrous oxide emissions, carbon sequestration, soil toxin purification or sequestration, yield, resource use efficiency, nitrogen use efficiency, water use efficiency, yield risk, revenue risk, costs, or revenues.

The process 500 applies the intervention 506. Applying the intervention adjusts the initial inputs 502 to generate updated inputs 508. The effect of the intervention may be dependent on the values of the initial inputs. For example, irrigation may increase the water level less effectively in sandy soil than in clay soil.

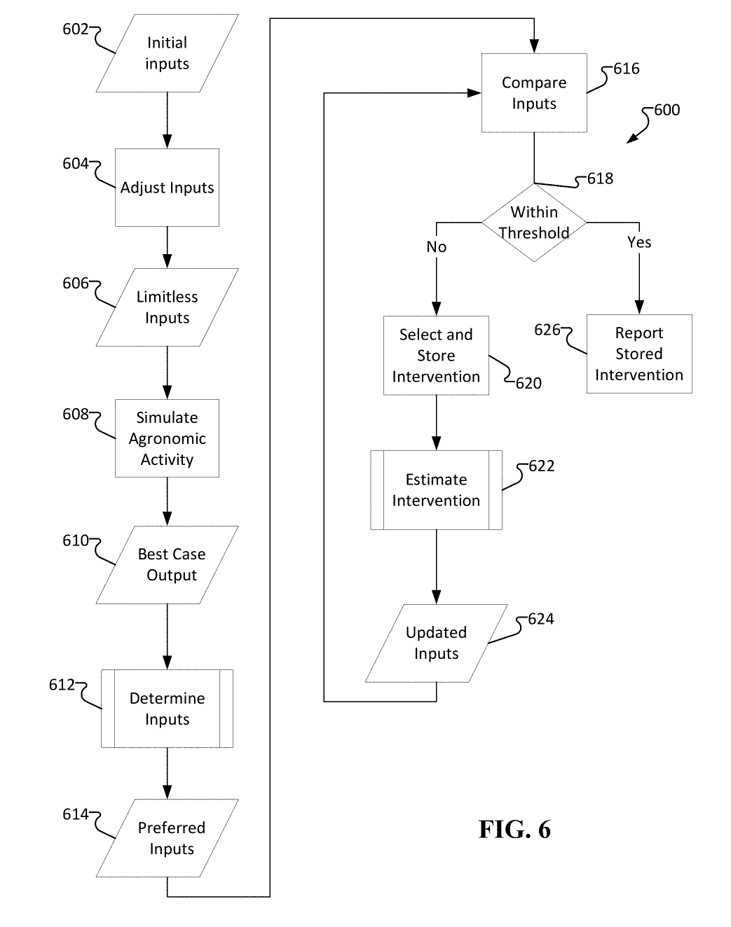

FIG. 6 illustrates a flow chart of a process 600 to increase agronomic output. The process 600 accepts initial inputs 602. The initial inputs may represent the current agronomic conditions of a farmable zone.

The process 600 adjusts 604 the inputs to generate limitless inputs 606. Limitless inputs are inputs in which at least one agronomic input is unconstrained. For example, the limitless inputs may assume that the farmable zone is not constrained by water and/or nitrogen.

The process 600 simulated 608 a “best case” agronomic activity of the farmable zone. The resulting output 610 represents a theoretical “best case” scenario for the agronomic output.

The process 600 can determine 612 the agronomic inputs necessary to produce the “best case” outputs 610. Determining the inputs necessary to produce the “best case” outputs may be done using, for example, the process 400 of FIG. 4, providing the “best case” output as the observed agronomic outputs 402 and the initial inputs 602 as the provided inputs 404. The resulting determined inputs 414 are the preferred inputs 614. In some implementations, the “best case” outputs may be a function including risk aversion, such that the value of “better” cases is discounted by the level of risk in achieving that outcome. In some implementations, the “best case” outputs may be a function including environmental sustainability metrics, commodity price risk, input costs, and/or revenues. In some implementations, selection of the preferred inputs may include an analysis of the sensitivity of the agronomic output to a particular agronomic input and/or the cost associated the adjusting the agronomic input.

The process 600 compares 616 the initial inputs 602 to the preferred inputs 614. The process 600 determines if the initial inputs 602 and the ideal inputs 614 are within a threshold distance of each other.

If the initial inputs 602 and the preferred inputs 614 are not within the threshold, then the process 600 selects 620 an intervention to adjust the initial inputs. In general, an intervention is an action that can be taken in the real world to affect one or more of the agronomic inputs. Some, but not all agronomic inputs are responsive to an intervention. For example, the nitrogen level of the soil may be adjusted through fertilization or the water level of the soil may be adjusted through irrigation. It is not practicable, however, to change the character of the soil (for example, from sandy to clay), therefore, the system selects agronomic characteristics that are responsive to intervention. As discussed above, the intervention may be a one-time event (for example, adjusting when to plant), a continuous event (for example, irrigation), or an event that occurs a predetermined times (for example, the application of fertilizer at various points during the growing season).

In some implementations, the system may select an agronomic characteristic to modify based on the agronomic inputs. For example, if a reference output indicates that the plants are yellowing in a farmable zone. If the model predicts no yellowing as a result of the agronomic inputs provided to the model that account for heat stress, drought stress, and nitrogen stress, the system may infer that that another agronomic characteristic is the cause (in this case there is probably an insect problem). The system may determine to adjust for the application of an insecticide even if the model does not accept the application of insecticide as an agronomic input.

The process 600 estimates 622 the effect of the intervention of the initial inputs. The process 600 may, for example, perform the operations described for the process 500 of FIG. 5. The updated inputs 624 may be compared 616 to the preferred inputs 614. When an intervention is applied, the intervention may be stored in a data store (either in volatile or non-volatile memory). In some implementations, interventions may be selected based on a desired level of management. For example, different interventions may be selected for a high management yield (to maximize the biological potential of the farmable zone), a technical management yield, and a low management yield. In some implementations, the interventions may be constrained by the logistical constrains of operating a plurality of farmable zones. For instance, yields may be maximized by applying fertilizer in the spring, but a farm agent may not be able to fertilize all of his fields in the spring and the system may recommend some fields to be fertilized in the preceding fall.

If the compared inputs are within the predetermined threshold, the stored interventions may be reported 626 as intervention plan. The intervention plan may be electronically transmitted as a set of instructions to a farm agent of the farmable zone.

The farm agent may transform the soil conditions or agronomic practices (including but not limited to cultivar or variety selection, crop selection, planting date and other customary farming practices) of the farmable zone by following the intervention plan. For example, a farm agent of a farmable zone may apply the prescribed interventions in order to achieve the agronomic potential of the zone. In some scenarios, following the prescribed intervention can improve the agronomic output. In other scenarios, following the prescribed intervention can improve environmental sustainability, or a weighted combination of agronomic output (or risk-adjusted revenue) and environmental sustainability. Improving an agronomic output can be either an increase in the agronomic output (for example, for crop yield) or a decrease in the agronomic output (for example, for nitrogen runoff).

The process 600 can be used for diagnostic purposes. For example, it may be used in “what if” scenarios to determine a theoretical maximum yield. As another example, it may be used to determine which agronomic input choices in a historical year lead to a deviation from the theoretical maximum yield. For instance, on a particular farmable zone, the historical choice of 30,000 corn plants per acre resulted in 10 bushels/acre lower yield than the optimal choice of 35,000 corn plants per acre would have. The process 600 can be used to determine an indication of how close the farmable region is to its potential. The process 600 can also be used to determine a measure of agronomic loss (such as a dollar loss in potential crops yield that did not materialize due to suboptimal interventions). The process can also identify the yield loss drivers (for example, which agronomic characteristics are contributing to the yield loss). By analyzing a plurality of historical years and the deviation from optimal management, the system can provide a measure of operator effectiveness.

The process 600 can be used to perform a sustainability analysis. For example, the process 600 can determine nitrogen use efficiency and water use efficiency. The process 600 can also determine carbon dioxide emissions or sequestration and soil organic carbon gain or loss (for instance due to tillage). In some implementations, the system can recommend interventions to increase the efficient use of resources.

The process 600 can be used proactively to determine a planning and intervention plan, either before a growing season or during the growing season. For example, a user may look at how a farmable zone has performed up to the current date, and then receive recommendations to maximize the potential for the remaining growing season. In some implementations, this can additionally be based on the inclusion of forecast weather data and/or seasonal weather predictions. The process 600 can recommend and track planting dates and make adjustments based on anticipated vs. actual flowering dates. For example, farm agents may tend to apply too much nitrogen to their farmable zones as an “insurance policy”, however, much of the excess nitrogen may run off. This run-off both pollutes the environment and constitutes a waste of money to the farm agent. The process can be used to calculate how much nitrogen is required in a given farmable zone at a pre-specified confidence level and provide an indication of the corresponding yield. If, for instance due to rainfall, the required nitrogen falls below the originally anticipated level, the process can be used to recommend an intervention to restore nitrogen to an acceptable level.

The process 600 can also be used for strategic planning. For example, the system may help a user determine the tradeoffs between short term gain and long term consequences (such as, fertilizer maximization vs. emissions and runoffs, yield vs. sustainability, short term losses vs longer-term gains in switching to no-till, crop rotation alternatives, etc.). The process 600 can also be used to make real estate and purchasing decisions. The potential “best case” agronomic output of the farmable region can be used as an input to determine the value of the farmable region.

The process 600 can be used to categorize a farmable region and/or farmable zones into risk categories. These categories may be continuous and accompanied by a risk score. By predicting the high and low yield potential of a particular farmable region of zone, and/or a continuum of potential yields, a system can categorize the region as low risk (e.g. a relatively small variance in expected yield under different scenarios) or high risk (e.g. a relatively large variance in expected yield under different scenarios). These scenarios may be specific to the geolocation of the farmable zone.

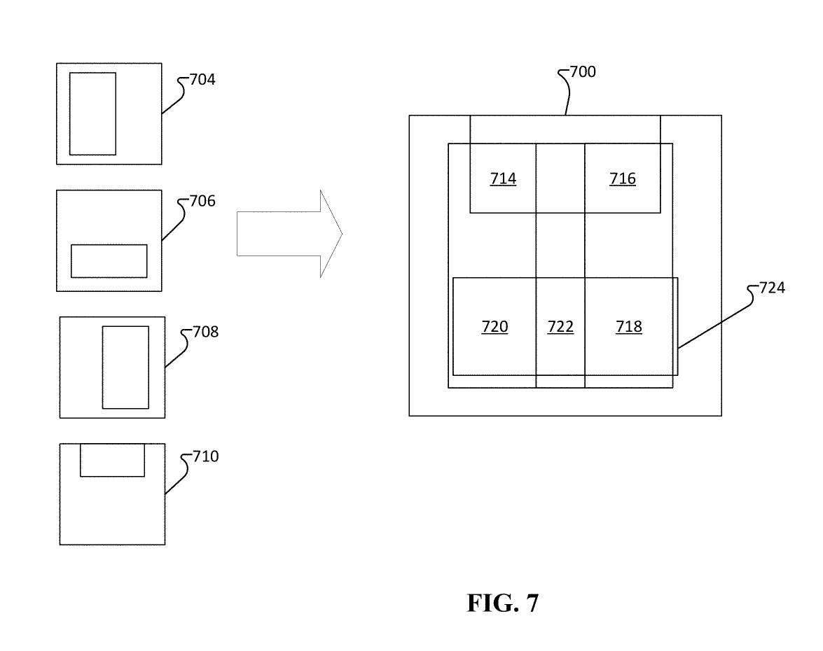

FIG. 7 illustrates the segmenting of a farmable region 700 into farmable zones 714, 716, 718, 720, 722, 724. A system can segment a farmable region into farmable zones based on expected agronomic characteristics of the zone. Generally, a farmable zone should have largely homogenous agronomic characteristics within the zone, whereas a farmable region may be heterogeneous. In some implementations, a farmable zone is sufficiently small as to maximize predictive or historical reconstruction power, regardless of the ability to manage or make interventions in such small zones. In some implementations, a farmable zone is the largest area for which a system makes an intervention plan. As such, the size of the farmable zone may be influenced by external factors, such as machinery switch over costs. The system may internally use an alternative or more finely grained set of farmable zones which may be aggregated or summarized to alternative or more coarsely grained zones depending on the type of intervention required. This granularity may be a function of the type of intervention. For instance, the system may make predictions on fine grained zones, summarize these prediction zones into more coarsely grained management zones for continuously variable rate nitrogen application, and into even more coarsely grained management zones for cultivar or crop selection and planting.

A system can accept different information about the farmable region in order to determine farmable zones. For example, the system can analyze location data (such as GPS coordinates) combined with yield maps (such as yield map 704), stability zones 706, soil survey zones 708, elevation zones 710. Other types of information may also be used, such as a water table map (not shown), soil samples, or remote sensing data. While each of the input maps shown include only two areas for presentation simplicity, in practice each of these input maps can include many different areas and regions. A homogenous zone may be comprised of a plurality of regions which are not spatially contiguous. Other information may also be used, for example, a water table map, satellite imagery, RADAR, LIDAR, and/or aerial imagery may provide input into the segmentation process.

The system overlays the information from the different information sources to identify the farmable zones (for example, farmable zones 714, 716, 718, 720, and 722). In some implementations, each identified farmable zone is a unique combination of areas from the input maps/data. In some implementations, farmable zones that are determined to be too small to be independently managed may be combined with a neighboring zone. For example, the farmable zone 724 may be combined with the farmable zone 718.

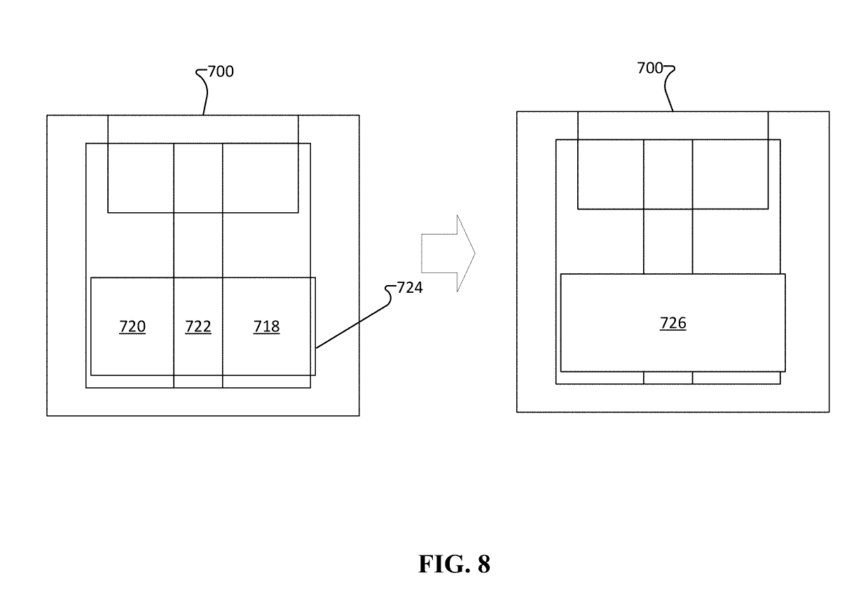

FIG. 8 illustrates an example of combining farmable zones based on agronomic characteristics. The system can identify the agronomic characteristics for one or more farmable zones within the farmable region 700. When the system determines that adjacent farmable zones have identical or sufficiently similar agronomic characteristics, the system may elect to combine the farmable zones into a single farmable zone.

For example, if the system determines that the farmable zones 720, 722, 718, and 724 each have the same or sufficiently similar agronomic characteristics, then the system may combine these farmable zones into the single farmable zone 726.

In some implementations, farmable zones may also be split into smaller farmable zones. For example, analyzing agronomic characteristics over a number of periods (such as years) may show a discrepancy or change in the homogeneity of the zone. In response, the system may divide the farmable zone into one or more additional zones.

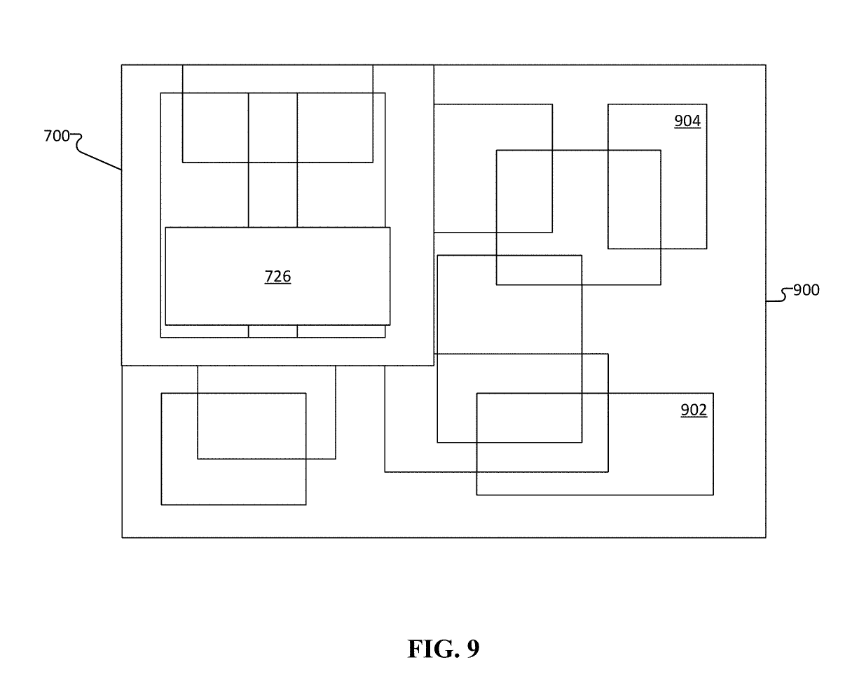

FIG. 9 illustrates assigning agronomic characteristics to a larger geographic area based on a farmable zone. A corollary to the insight that if the same cultivar experiences different yields in different areas of a farmable region then the difference in yield must be caused by different agronomic characteristic is the insight that if the same cultivar experiences the same yield in different farmable regions then the farmable regions must share agronomic characteristics. In some implementations, this large geographic area may be geographically distant from the farmable zone but may still have its characteristics assigned from the farmable zone on the basis of the similarity of its response of agronomic outputs.

In this example, a larger geographic area 900 includes the farmable region 700 and the farmable zone 726. The larger geographic area may be divided into areas (for example, areas 902 and 904). In some implementations, the larger geographic area may be divided based on less information than is used to create the farmable zones of FIG. 7. For example, the areas 902 and 904 may be determined based solely on yield maps. In some implementations, the areas 902 and 904 may be farmable zones identified using a similar process as described above.

If the system determines, for example, that the farmable zone 726 and the area 904 have similar yield characteristics (or other agronomic outputs) then the system may assign the agronomic characteristics of the farmable zone 726 to the area 904. In this way, information from one farmable zone can be used to extrapolate information from other areas in a larger geography. A similar process may be used to assign agronomic characteristic to different farmable zones that experience similar agronomic outputs. In some implementations, the agronomic outputs or a summary thereof (such as by PCA, principle components analysis) may be stored in a data store with the corresponding agronomic inputs, the agronomic outputs or a summary thereof of a target geographic area may then be input, a similarity measure such as Euclidian distance may be computed, and the inferred agronomic inputs for the target geographic area may be selected from the data store by looking up the associated outputs by a selection process of the similarity measure, such as nearest neighbor. In other implementations, the similarity measure and selection process may be replaced with selecting the most farmable zone's input parameters whose output parameters were most likely to have been generated by the same stochastic process which generated the target geographic area's output parameters.

In this manner, the crop yield and other agronomic outputs for the entire geographic region may be predicted.

This process forgoes the need to perform the simulation process on each farmable zone in a larger geographic region and thereby improves the computational efficiency of determining agronomic characteristics.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs (i.e., one or more modules of computer program instructions, encoded on computer storage mediums for execution by, or to control the operation of, data processing apparatus). A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices). The computer storage medium can be non-transitory.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example, a programmable processor, a computer, a system on a chip, or multiple ones, or combinations, of the foregoing. The apparatus can include special purpose logic circuitry (e.g., an FPGA (field programmable gate array) or an ASIC (application-specific integrated circuit)). The apparatus can also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural or object-oriented or functional languages, and it can be deployed in any form, including as a stand-alone program or as a module, component, subroutine, service, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry (e.g., an FPGA (field programmable gate array) or an ASIC (application-specific integrated circuit)).

Processors suitable for the execution of a computer program include, by way of example, both general and special purpose microprocessors, and any one or more processors of any kind of digital, analog or quantum computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive, data from or transfer data to, or both, one or more mass storage devices for storing data (e.g., electronic, magnetic, magneto-optical disks, or optical disks), however, a computer need not have such devices. Moreover, a computer can be embedded in another device (e.g., a mobile telephone, a personal digital assistant (PDA), a mobile audio or video player, a game console, a GPS receiver, or a portable storage device (e.g., a universal serial bus (USB) flash drive)), to name just a few. Devices suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback) and input from the user can be received in any form, including acoustic, speech, or tactile input. In addition, a computer can interact with a user by sending documents to and receiving documents from a device that is used by the user (for example, by sending web pages to a web browser on a user's user device in response to requests received from the web browser).

Embodiments of the subject matter described in this specification can be implemented in a computing system that includes a back-end component (e.g., as a data server), a middleware component (e.g., an application server), or a front-end component (e.g., a user computer having a graphical user interface or a Web browser through which a user can interact with an implementation of the subject matter described in this specification), or any combination of one or more such back-end, middleware, or front-end components. The components of the system can be interconnected by any form or medium of digital or optical data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system comprising:
one or more sensors for collecting data indicative of reference values of a plurality of agronomic inputs and a reference value of a crop yield for a farmable zone;
one or more databases storing data records comprising the collected data indicative of the reference values of the agronomic inputs and the reference value of the crop yield for the farmable zone;
one or more processing devices; and
one or more machine-readable hardware storage devices comprising instructions that are executable by the one or more processing devices to cause the one or more processing devices to perform operations comprising:
retrieving, from the one or more databases, the data records comprising the collected data indicative of the reference values of the agronomic inputs and the reference value of the crop yield for the farmable zone;
parsing the retrieved data records to identify the reference values of the agronomic inputs;
performing one or more iterations of an iterative process, including:
generating a set of values of an input set of agronomic inputs including a potential value of an agronomic input by selecting the set of values from a collection of possible sets of values of sets of agronomic inputs for the farmable zone;
generating data indicative of a predicted value of the crop yield for the farmable zone by applying an agronomic simulator to the generated set of values of the input set of agronomic inputs; and
determining a score for the set of values of the input set by applying a scoring function to the predicted value of the crop yield and the reference value of the crop yield,
wherein, for a first of the iterations, the generated set of values of the input set is generated based, at least in part, on the reference values of the plurality of agronomic inputs, and
wherein, for each iteration subsequent to the first iteration, the generated set of values of the input set is generated based, at least in part, on the score determined in the previous iteration;
determining inferred values of a set of agronomic inputs for the farmable zone based, at least in part, on the scores for the sets of values; and
presenting a recommendation to transform one or more soil conditions of the farmable zone based, at least in part, on the inferred values of the set of agronomic inputs.

2. The system of claim 1, wherein selecting a set of values of a set of agronomic inputs for the farmable zone based, at least in part, on the comparison of the previous iteration comprises:
determining a sensitivity of the crop yield to values of at least one agronomic inputs; and
selecting the set of values of the set of agronomic inputs based, at least in part, on the determined sensitivity of the predicted value of the crop yield to the values of agronomic input.

3. The system of claim 1, wherein presenting the recommendation to transform the soil conditions of the farmable zone comprises:
updating the inferred values of the agronomic inputs to reflect a predicted effect of applying at least one intervention to the farmable zone;
generating data indicative of an updated predicted value of the crop yield for the farmable zone by applying the agronomic simulator to the updated inferred values of the agronomic inputs; and
in response to determining that the updated predicted crop yield represents an increase over the reference crop yield, generating a report identifying the intervention.

4. The system of claim 3, wherein determining that the updated predicted crop yield represents an improvement over the reference crop yield comprises determining that the updated predicted crop yield is greater than the reference crop yield.

5. (canceled)

6. The system of claim 1, wherein selecting a set of values of a set of agronomic inputs from the collection of possible sets of values of sets of agronomic inputs comprises:
identifying, in the collection, a possible set of values including a value of an agronomic input that is outside a threshold value; and
excluding the identified possible set of values from selection.

7. The system of claim 1, wherein comparing the predicted value of the crop yield to the reference value of the crop yield comprises applying a scoring function to the predicted value of the crop yield and the reference value of the crop yield; and wherein, for each iteration subsequent to the first iteration, the selected set of values of agronomic inputs is selected based, at least in part, on a result of the scoring function.

8. The system of claim 1, wherein the operations further comprise:
segmenting a farmable region into one or more farmable zones based, at least in part, on one or more of a yield map, stability map, soil survey map, satellite map, and elevation map, wherein the one or more farmable zones include the farmable zone and one or more other farmable zones; and
determining inferred values of sets of agronomic inputs for each of the one or more other farmable zones.

9. The system of claim 1, wherein presenting a recommendation to transform one or more soil conditions of the farmable zone based, at least in part, on the inferred values of the agronomic inputs comprises presenting a recommendation to alter one or more levels of one or more nutrients in the soil or a water level of the soil.

10. (canceled)

11. A data processing apparatus comprising:
one or more databases storing data records representative of reference values of a plurality of agronomic inputs to a farmable zone and a reference value of an agronomic output of the farmable zone;
one or more processing devices; and
one or more machine-readable hardware storage devices storing instructions that are executable by the one or more processing devices to cause the one or more processing devices to perform operations comprising:
accessing, from the one or more databases, the stored data records;
performing one or more iterations of an iterative process, including:
generating a set of values of an input set of agronomic inputs including a potential value of an agronomic input of the farmable zone;
generating a predicted value of the agronomic output by applying an agronomic simulator to the generated set of values of the input set of agronomic inputs, and
based on the predicted value of the agronomic output, determining a score for the set of values of the input set by applying a scoring function to the predicted value of the agronomic output and the reference value of the agronomic output,
wherein, for a first of the iterations, the generated set of values of the input set is generated based, at least in part, on the reference values of the plurality of agronomic inputs, and
wherein, for each iteration subsequent to the first iteration, the generated set of values of the input set is generated based, at least in part, on the score determined in the previous iteration;
selecting, from the generated sets of values of input sets of agronomic inputs, a particular set of values of an input set of agronomic inputs based on a score of the particular set of values relative to scores of other sets of values of the input set; and
determining an inferred value of the agronomic input of the farmable zone based, at least in part, on the particular set of values of the input set.

12. The data processing apparatus of claim 11, wherein the operations further comprise:
segmenting a farmable region into one or more farmable zones based on one or more of a yield map, stability map, soil survey map, satellite map, and elevation map; and
determining inferred values of a plurality of agronomic inputs for each of the one or more farmable zones.

13. The data processing apparatus of claim 12, wherein the operations further comprise merging a first farmable zone of the one or more farmable zones and a second farmable zone of the one or more farmable zones based on the determined values of the agronomic inputs.

14. The data processing apparatus of claim 12, wherein the inferred value of the agronomic input is for a first of the one or more farmable zones, and wherein the operations further comprise extrapolating the inferred value of the agronomic input for the first farmable zone to a geographic area larger than the first farmable zone.

15. The data processing apparatus of claim 14, wherein the extrapolation is based, at least in part, on a measure of similarity between an historic crop yield in the first farmable zone and an historic crop yield in the geographic area.

16. The data processing apparatus of claim 11, wherein the plurality of agronomic inputs comprise at least one of a water agronomic input, a nitrogen agronomic input, and a water and nitrogen agronomic input representative of weather conditions over a growing season.

17. A system comprising:
one or more processing devices; and
one or more machine-readable hardware storage devices comprising instructions that are executable by the one or more processing devices to cause the one or more processing devices to perform operations comprising:
accessing, from a database, data records including collected data representing reference values of a plurality of agronomic inputs and reference values of one or more agronomic outputs of a farmable zone;
obtaining an input set of values of one or more of the agronomic inputs from the reference values of the agronomic inputs in the collected data;
predicting an output set of values of one or more agronomic outputs by applying an agronomic simulator to the input set;
using a metaheuristic to determine scores for the input set comprising:
scoring a saliency of the output set based, at least in part, on the reference values of the agronomic outputs, and
determining the scores for the input set based, at least in part, on the scored saliency of the output set; and
determining an inferred value of an agronomic input of the farmable zone based on the scores of the input set.

18. The system of claim 17, wherein the metaheuristic comprises a Markov chain Monte Carlo model, an approximate Bayesian computation model, a trans-dimensional Markov chain Monte Carlo model, a simulated annealing model, a neural network, a particle swarm optimization model, and/or a simultaneous perturbation stochastic approximation model.

19. The system of claim 17, wherein scoring the saliency of the output set comprises comparing the values of the agronomic outputs in the output set to the reference values of the agronomic outputs in the output set, wherein the output set of values is a first output set of values, and wherein the operations further comprise:
updating the values of the agronomic inputs in the input set based on the saliency of the output set; and
predicting a second output set of values of one or more agronomic outputs by applying the agronomic simulator to the updated input set.

20. The system of claim 17, wherein the output set of values is a first output set of values, and wherein the operations further comprise:
updating the inferred value of the agronomic input to reflect a predicted effect of applying at least one intervention;
updating the input set of values of agronomic inputs to reflect the updated inferred value of the agronomic input;
predicting a second output set of values of one or more agronomic outputs by applying the agronomic simulator to the updated input set; and
in response to determining that the second output set of values of agronomic outputs represents an improvement over the first output set of values of agronomic outputs, presenting a recommendation to apply the intervention.

21. The system of claim 20, further comprising a device for transforming soil conditions and/or agronomic practices of the farmable zone by applying the intervention.

22. The system of claim 17, wherein the operations further comprise:
selecting, from the plurality of agronomic inputs, the one or more agronomic inputs included in the input set, wherein the selection of the one or more agronomic inputs is based on a sensitivity of at least one agronomic output to at least one agronomic input.

23. The data processing apparatus of claim 17, wherein the operations further comprise:
selecting, from the plurality of agronomic inputs, the one or more agronomic inputs included in the input set, wherein the selection of the one or more agronomic inputs is based on a cost associated with altering at least one agronomic input to affect at least one agronomic output.

24. A method performed by a data processing apparatus, the method comprising:
accessing, from a database, data records including collected data representing reference values of a plurality of agronomic inputs and reference values of one or more reference agronomic outputs of a farmable zone;
obtaining an input set of values of one or more of the agronomic inputs from the reference values of the agronomic inputs in the collected data;
predicting an output set of values of one or more agronomic outputs by applying an agronomic simulator to the input set;
using a metaheuristic to determine scores for the input set comprising:
scoring a saliency of the output set based, at least in part, on the reference values of the agronomic outputs, and
determining the scores for the input set based, at least in part, on the scored saliency of the output set; and
determining an inferred value of an agronomic input of the farmable zone based, at least in part, on the scores of the input set.

25. The method of claim 24, further comprising selecting a metaheuristic from a list comprising a Markov chain Monte Carlo model, an approximate Bayesian computation model, a trans-dimensional Markov chain Monte Carlo model, a simulated annealing model, a neural network, a particle swarm optimization model, and/or a simultaneous perturbation stochastic approximation model.

26. The method of claim 24, wherein scoring the saliency of the output set comprises comparing the values of the agronomic outputs in the output set to the reference values of the agronomic outputs in the output set, wherein the output set of values is a first output set of values, and wherein the method further comprises:
updating the values of the agronomic inputs in the input set based on the saliency of the output set; and
predicting a second output set of values of one or more agronomic outputs by applying the agronomic simulator to the updated input set.

27. The method of claim 24, wherein the output set of values is a first output set of values, and wherein the method further comprises:
updating the inferred value of the agronomic input to reflect a predicted effect of applying at least one intervention;
updating the input set of values of agronomic inputs to reflect the updated inferred value of the agronomic input;
predicting a second output set of values of one or more agronomic outputs by applying the agronomic simulator to the updated input set; and
in response to determining that the second output set of values of agronomic outputs represents an improvement over the first output set of values of agronomic outputs, presenting a recommendation to apply the intervention.

28. The method of claim 27, further comprising transforming soil conditions and/or agronomic practices of the farmable zone by applying the intervention.

29. The method of claim 24, further comprising:
selecting, from the plurality of agronomic inputs, the one or more agronomic inputs included in the input set, wherein the selection of the one or more agronomic inputs is based on a sensitivity of at least one agronomic output to at least one agronomic input.

30. The method of claim 24, further comprising:
selecting, from the plurality of agronomic inputs, the one or more agronomic inputs included in the input set, wherein the selection of the one or more agronomic inputs is based on a cost associated with altering at least one agronomic input to affect at least one agronomic output.
